(19) United States
(12) Patent Application Publication
(10) Pub. No.: US 2016/0339606 A1
(43) Pub. Date: Nov. 24, 2016

(54) High Temperature Plaster Tooling

(71) Applicant: Matt Wallen, Vail, AZ (US)

(72) Inventor: Matt Wallen, Vail, AZ (US)

(21) Appl. No.: 14/716,858

(22) Filed: May 19, 2015

(51) Int. Cl. B29C 33/38

(52) U.S. Cl. CPC B29C 33/38; B29K 2307/04

(57) ABSTRACT

Although plaster (gypsum) loses water at temperatures above 300° F. and converts to plaster of Paris that has reduced structural strength, plaster (gypsum) is used in this invention as a mandrel (form or mold) at temperatures in excess of 300° F., at about 600° F. or higher in the manufacture of composite products or other products, such as metals, requiring exposure at such high temperatures.

According to this invention, a plaster mandrel is effective with controlled exposure to such high temperature. Specified additive(s) to plaster, used according to this invention, greatly expand the utility of plaster containing mandrels in high temperature applications.

### RELATED APPLICATIONS

This application claims the benefits of U.S. Provisional Application 62/001,034, filed May 20, 2014, and U.S. Provisional Application 62/038,233, filed Aug. 16, 2014.

### BACKGROUND OF THE INVENTION

Composite plastic parts are of great value in industry because of their high strength and light weight. Tubular, simple, and complex structures are produced by wrapping or coating a core mold, or mandrel, with the composite and curing the composite at appropriately high temperature. The product can be tubular with no seam, being of continuous structure in circumference and length.

Multiple problems arise, however, in creating a core mold of sufficient strength, appropriate surface characteristics, compatibility with the composite and the curing process, and ease of removing the core from the cured composite structure without damage to the composite or significant additional cost.

Core molds, or mandrels, have been made with sand and binders, plaster, plaster mixed with various binders, fillers such as cenospheres or graphite. Each of these approaches has proved to present problems in having inadequate strength to hold up in coating or wrapping, poor surface characteristics of the mandrel requiring further work on the surface, interference of residual moisture or other chemicals with the curing (and producing defects in) the composite, or difficulty in removing the mandrel (core mold) from the cured composite product.

Plaster has been a much used mandrel material or component because it is cheap, easily handled, and has desirable surface characteristics when hardened. However, plaster containing binders can negate the ease in handling and also be difficult to remove from some composite products. In addition, residual water in plaster-containing mandrels becomes water vapor as the composite is heated to high curing temperatures. The resulting water vapor interferes with the curing composite and creates defects and flaws in the composite. Such mandrels are most useful only for composites with low curing temperatures.

Therefore, partial drying of plaster-containing mandrels is done prior to wrapping or coating the mandrel with composite material. However, the plaster loses its strength upon removing water, severely limiting the proportion of water that can be removed without destroying the required strength of the mandrel.

The development of high performance thermoplastics that soften at temperatures much higher than the curing temperatures of typical composites presents a serious challenge for molds and tooling materials on which products are formed. Whereas thermoset plastics have previously been formed at temperatures around 350° F., newer high temperature thermoplastics do not decrease their viscosity to allow forming until they reach temperatures near or in excess of 600° F. The high forming temperature presents challenges for molds that can withstand the molding temperature and that subsequently can be removed from the finished thermoplastic product. Robust tooling materials such as metals, ceramics, etc. withstand the high temperatures, but present difficulties in removing them from the product. New tooling concepts are needed for these high performance/high molding temperature materials.

In addition, the need to remove the tooling from the finished shape affects what can be produced and how complex a part may be designed. Historically, complex hollow composite/plastic shapes could be produced utilizing polymer bound aggregate shapes that could be softened with water to remove the shape from the finished composite/plastic part. The high temperatures required with these new materials, however, readily degrade the polymers in this type of tooling, making them either unusable strength-wise or non-removable.

Although plaster (gypsum) has been used as a mold material for thermoplastic products produced at lower temperatures, it is an unlikely candidate for use at high temperatures. CaSO₄ materials or plaster have been used for quite some time in the processing and forming of materials ranging from plastics to metal or even glass. However, when it comes to composites, their utility is limited in that although they retain their strength when cast and formed from plaster of Paris mixed with water to form di-hydrate calcium sulfate, they must be heated for an extended duration to temperatures that force the dehydration of the calcium sulfate into its original hydration state which results in loss of properties from the casting. For example, a plaster mandrel utilized in a typical carbon/epoxy pre-preg cure cycle will undergo 350° F., 90 Psi cure conditions for several hours over which time the gypsum high strength casting will lose its properties and water. This is typically why plaster is only utilized as a tooling material below 300° F. However, since the plaster mandrel has been liquid cast into its final shape and upon solidification results in a highly ordered crystal state upon conversion to gypsum (di-hydrate Calcium Sulfate), with subsequent heat-induced dehydration the shape is able to retain enough strength to process a thermoplastic part as long as the shape is not thermally stressed beyond its limits.

Modifications to the base dehydrated plaster material are needed to stabilize it in the dehydrated state.

### SUMMARY OF THE INVENTION

Although solid gypsum loses water at temperatures above 300° F., consequently losing strength, a mandrel composed of gypsum is used to create a product with high temperature thermoplastic material near or above 600° F. with this invention. Additional advantages are produced by incorporating specified additives in the plaster before forming a mandrel, creating a mandrel with many applications at high temperatures near or in excess of 600° F.

### DESCRIPTION OF THE INVENTION

### Using Gypsum to Fabricate Thermoplastics in Excess of 600° F.

Plaster of Paris is a dry powder typically produced by heating (calcining) solid gypsum (calcium sulfate di-hydrate) at or above 300° F. until the water is removed from the gypsum. Plaster of Paris mixed with water forms slurry that sets into solid gypsum.

In this invention, plaster of Paris is cast into the desired removable shape resulting in a gypsum or (di-hydrate-CaSO4). After the plaster is hydrated/solidified it is then either sealed or directly utilized in the formation of the high temperature thermoplastic, depending on the plastic processing requirement. When the high temperature thermoplastic material is formed around the casting, the outer surface of the casting is immediately converted into the anhydrous form CaSO₄. Just below this anhydrous layer there are varying degrees of hydration level within the casting at any period of time during the thermoplastic forming process. The remaining hydration in the interior of the plaster mold maintains the casting's mechanical stability. Interestingly, the new high temperature thermoplastics do not required the long cure cycles imposed by the thermo-set plastic's chemical requirements. (The thermoplastics simply melt shape and cool to solidify/crystallize.) The amount of time the casting is exposed to the extreme condition is brief. Also the time that the casting needs to be at its highest strength is when it is being surrounded by the molten thermal plastic. This is also when the plaster has its highest hydration level. After the plaster is surrounded by the molten thermoplastic, the requirements on the casting's mechanical properties are diminished, as the casting is now held in isostatic compression as the part is quickly cooled. It is only through the reduction in the processing time and the short exposure to elevated temperature that Gypsum plaster can be utilized as a high temperature mold. Depending on the geometry and thickness of the mold, the formed product can be post processed to dehydrate the mandrel at between 320° and 380° F. and converted into hemi-hydrate or back to soluble plaster of Paris. As the thermoplastic remains solid at these temperatures, there is little to no effect on the final plastic part from this post processing.

Remarkably and counter-intuitively, plaster serves as a mold form for high temperature (near or in excess of 600° F.) thermoplastics. Although the high temperature rapidly causes the release of water from the surface of the plaster mold when the mold is immersed in the liquid plastic, returning the surface plaster to powder form, the short time of immersion results in a gradient of moisture content in the plaster mold, retention of hydration internally, and retention of the plaster mold shape. Thus plaster serves as an effective mold for high temperature thermoplastics when the process is carefully controlled with limited exposure of the mold to the high temperature. In addition, after the thermoplastic product is formed, the plaster mold is readily dissolved and washed out with water.

In addition, plaster can be utilized in the making of a mandrel or core for use with these high temperature plastics with a previous invention of plaster incorporating a cross-linked polymer matrix (U.S. patent application Ser. No. 14/679,034, filed Apr. 6, 2015, incorporated herein by reference). The matrix of that invention maintains the strength and shape of the mandrel or mold at temperatures that cause the dehydration of plaster. Use of the plaster mold that contains a cross-linked polymer matrix alters the need to carefully control the time of exposure of the mold to the elevated temperatures of around or greater than 600° F. As the polymer modified plaster is taken to elevated temperature, it first dehydrates to plaster of Paris and is stabilized by the polymer matrix until around 500° F. at which time the polymer starts to degrade under the thermal gradient. However, as the thermoplastic forming process can be rapid (less than 60 sec) in some processes, the extent of polymer decomposition is limited. After thus forming the thermoplastic product, the mandrel can be removed easily with water.

In addition, the utilization of additives such as cenospheres or other aggregate allow the plaster to be stabilized. One large issue that occurs with calcining plaster molds is the thermal cracking that is induced in pure plaster. Additives reduce the risk of thermal cracking, producing a removable calcined plaster mold. By using a low coefficient of thermal expansion (CTE) additive, the bulk CTE of the mixture is minimized, greatly reducing the risk of thermal gradient induced cracking and failure in the dehydrated plaster of Paris mandrel.

In addition, just as the reduction in CTE in the dehydrated plaster materials creates reductions in mechanical stress afforded to the plaster of Paris shape, stress reduction is also achieved by increasing the thermal conductivity of the shape. This is accomplished by adding a low CTE thermally conductive material such as graphite. These types of additives lessen the effects of non-uniform heat gradient on the material by reducing the gradient itself. In other words, the effects due to a large CTE are minimized if the material itself is easier to heat more uniformly. Because the stress is induced by areas of the material changing size at different rates, reducing the temperature gradient within the mandrel reduces stress.

Incorporation of aggregate material into the liquid stage mixing of the plaster of Paris results in the added aggregate setting into the hydrating plaster. Upon calcining, the removal of the hydration water from the plaster changes the plaster crystal structure and with it the mechanical properties. However, the incorporation of an additive helps to stabilize the structure both thermally and mechanically upon calcination, resulting in a mechanically stable, removable plaster mandrel. Cenospheres are utilized as the primary additive but iron oxides and other additives known to those skilled in the art may be incorporated to stabilize the calcined plaster.

In one embodiment of the invention, cenospheres are mixed with the plaster in excess of 5% cenosphere to plaster content and cast into the desired shape at an appropriate water mixture for casting. After the mixture has set and de-molded, the mandrel is placed directly into a 400° C. oven for calcination. Depending on the cross sectional area, the calcining times are adjusted so the entire mandrel is converted. This newly calcined plaster/cenosphere mixture is soluble/removable with pressurized water and may even be recycled. After the mandrel has been fabricated via calcination, it is ready for thermoplastic fabrication. This can be accomplished directly or with use of a surface sealer. Typical sealers range from Kapton films and Teflon to high temperature silicone coatings, depending on the thermoplastic being processed.

In one embodiment of the invention, the mandrels are utilized in a thermoplastic press or injection method in which the high temperature thermoplastic is formed around the high temperature plaster/cenosphere mandrel. Since the mandrel has already been “tempered” at the processing temperature and since there is no longer any water remaining, the mandrel is stable and able to withstand most processing conditions. After the thermoplastic is formed around the mandrel, the mandrel is simply removed with the application of pressurized water.

In one example, the stabilized, dehydrated ½H₂O CaSO₄ mandrel is directly shaped utilizing a subtractive manufacturing process such as CNC machining, or lathing, etc. In this embodiment a near net shape with the required holding shape for the subtractive process is cast from the stabilized plaster mixture, which upon hydrating into the gypsum version of the material is shaped (machined) into the required net shape. After machining, the final shape is then calcined (dehydrated) to plaster of Paris (½H₂O CaSO₄). The dehydrated shape can then be sealed if necessary for plastics processing or left bare for casting with metals, etc. This method produces a mechanically stable directly machined tooling material that mitigates having to produce a casting mold to produce the required shape.

In one embodiment of the invention the material is either cast or machined to the desired shape and dehydrated. As the material is now stabilized with the incorporation of the stabilizing aids, molten metal can now be directly cast into or around the material without out gassing that would occur from hydrated gypsum. The net effect of the elimination of out gassing from dehydration is two-fold. First the fidelity of the surface of the dehydrated plaster that comes into contact with the molten metal does not need to be porous to allow trapped gasses to escape. This affords a better surface finish when contacting the molten metal. Second the plaster surface itself has a much finer detail than can be achieved with typical sand or even cenosphere type tooling commonly utilized in the metal casting issue.

Another important consideration is the utilization of a surface sealer that is amendable to the end use mandrel processing condition. A surface sealer is needed if the material forming around the mandrel can penetrate the dehydrated casting surface. A range of sealers can be selected for the desired processing conditions. Some examples include the utilization of high temperature plastics such as polyimides, Kapton, Teflon, ETFE, polyurethane, or others known to those skilled in the art, applied using methods known to those skilled in the art, such as powder coat, liquid spray, film/tape application, etc.

Another important aspect is the utilization of either the gypsum or the plaster of Paris form of the material cast into the desired shape for utilization in high temperature thermoplastic injection molding. This is most applicable for thermoplastics in excess of 600° F. with and without short and long fiber re-enforcement. The mandrels are prepared to the required shape and dehydration state and placed into the cavity of the injection mold. The mold is then compressed closed and the liquid thermoplastic is quickly formed around the mandrel. Depending on the starting state of the mandrel, the finished part with the plaster mandrel inside may then be post processed dehydrated to get the mandrel to a removable state.

### High Temperature Thermally Expandable Removable Mandrel

Utilizing the same thermally stable dehydrated plaster material described above, a thermally self-expanding mandrel can be created by adding the expandable graphite flake to plaster slurry prepared from mixing plaster and water. The expandable graphite loading may be added anywhere from 1-50% of the total mixture depending on the complexity of the final mandrel that is desired. Increases in graphite content lead to increases in viscosity, so consideration must be given for final mandrel complexity. High viscosity liquid slurry mixes can be pumped into the desired shape, if the mixture is too viscous to pour. The plaster mandrel is then carefully dehydrated at less than 300° F. before processing. The stabilized plaster with the expandable graphite is able to be dehydrated from (2H₂O—CaSO₄ to ½ H₂O—CaSO₄) which makes the plaster soluble again and in turn able to be removed from the formed plastic article. Other inventions have sought to utilize an expandable graphite infused gypsum mandrel but are limited by both the significant increase in processing time and the inability to utilize the solubility afforded by utilizing a stabilized plaster along with expandable graphite. Prior art that utilizes expansive behavior afforded by intercalated graphite is plagued by the fact that it is difficult to get thermal energy first through the outer metal mold, then through the composite layers, and finally into the mandrel where a large quantity of excess water must be removed before the actual forming process can be initiated. The current invention significantly reduces the amount energy that must be put into the system in order to form the desired part. This is accomplished by first dehydrating the plaster which has been historically difficult without the addition of the stabilization described above.

The prior art does not describe the benefits of this route as it does not have a means to avoid the extra time and energy requirement and simply accepts the longer processing time, as in US 2014/0167319 A1 and Eurocopter patents.

### Example

A high temperature plaster matrix based material with a low CTE additive such cenospheres or graphite in the range of 1-40% by weight to the plaster content is utilized to form a mandrel. The plaster may be either an alpha or beta plaster, depending on strength requirements. The resulting mandrel must be heated in excess of 300° F. long enough to dehydrate the gypsum to plaster of Paris, depending on plaster content and the original amount of water utilized to hydrate the mixture upon formation of the mandrel.

### Expandable Example

The same material ranges disclosed above, with the addition of expandable graphite in the range of 0.1 to 70% of the plaster content. Again the mixture is mixed with water (hydrated) and shaped/poured into its final shape after which the plaster matrix hardens to form the desired shape. The hardened shape must then be dehydrated at more than 220° F. and less than 300° F. so that the water is removed but the expandable graphite is not activated. The additives allow the mandrel to remain stable for handling and post processing after the removal of the hydration water.

What is claimed:

1. The method of making a product from high temperature thermoplastic comprising the steps:
a. Forming the desired mandrel by casting hydrated plaster of Paris into the desired mandrel shape,
b. Forming a thermoplastic around such mandrel,
c. Solidifying the thermoplastic by cooling.
d. Rapidly removing such mandrel from solidified thermoplastic.

2. A plaster mandrel containing an effective amount of a low coefficient of thermal expansion additive to allow such mandrel to be calcined without cracking or failing.

3. A plaster mandrel of claim 2 containing about 1% to about 50% by weight of a low coefficient of thermal expansion additive.

4. A plaster mandrel containing an effective amount of thermal conductivity additive that allows the thermal gradient to be reduced on the mandrel to reduce risks of cracking or failing during thermal processing.

5. A plaster mandrel of claim 4 containing about 0.1% to about 60% by weight of a high thermal conductivity additive.

6. A thermally expandable plaster of hemi-hydrate (not gypsum) mandrel containing 0.1% to 70% expandable graphite.

7. A thermally expandable plaster based mandrel of claim 6 that has been dehydrated into a stabilized hemi hydrate.

8. A method of making a product from high temperature thermoplastic comprising steps:
a. forming a mandrel from hydrated plaster of Paris containing an effective amount of additive allowing the resulting mandrel to be calcined without cracking or failing,
b. calcining said mandrel,
c. forming molten high temperature thermoplastic at a temperature of about 600° F. or higher around said formed mandrel,
d. immediately solidifying said high temperature thermoplastic by cooling, and
e. removing said mandrel from said solidified high temperature thermoplastic.

9. The method of claim 8 when said additive is a low coefficient of thermal expansion additive at a concentration of about 1% to about 40% by weight.

10. The method of claim 9 when said additive is cenospheres.

11. The method of claim 9 when said additive is graphite.

12. A method of making a product from molten metal comprising steps:
a. forming a mandrel from hydrated plaster of Paris containing an effective amount of additive allowing the resulting mandrel to be calcined without cracking or failing,
b. calcining said mandrel,
c. forming molten metal around said formed mandrel,
d. immediately solidifying said metal by cooling, and
e. removing said mandrel from said solidified metal.

13. The method of claim 12 when said additive is a low coefficient of thermal expansion additive at a concentration of about 1% to about 40% by weight.

14. The method of claim 13 when said additive is cenospheres.

15. The method of claim 13 when said additive is graphite.
